(19) United States
(12) Patent Application Publication
(10) Pub. No.: US 2019/0242790 A1
(43) Pub. Date: Aug. 8, 2019

(54) Methods and Apparatuses for Cutting Specimens for Microscopic Examination

(71) Applicant: Nanotronics Imaging, Inc., Cuyahoga Falls, OH (US)

(72) Inventors: Matthew C. Putman, Brooklyn, NY (US); John B. Putman, Celebration, FL (US); Alejandro S. Jaime, Hollister, CA (US); Randolph E. Griffith, Hollister, CA (US)

(21) Appl. No.: 15/890,829

(22) Filed: Feb. 7, 2018

(51) Int. Cl. G01N 1/06

(52) U.S. Cl. CPC G01N 1/06; G01N 1/2813

(57) ABSTRACT

Cutting apparatuses comprising: a base; a first platen and a second platen that are coupled to the base and that are configured to hold a specimen, wherein the first platen includes a first cutting surface and the second platen includes a second cutting surface; a moveable carriage that is moveably coupled to the base; a cutting arm that is pivotably coupled at a pivot point to the carriage and that is configured to hold a cutting blade; and a spring coupled to the arm so as to apply a directional force to the arm and the blade, wherein the moveable carriage can be moved in a manner that causes the blade to slide on at least one of the first cutting surface and the second cutting surface while being pressed against the at least one of the first cutting surface and the second cutting surface by the directional force.

### TECHNICAL FIELD

The present disclosure relates to cutting specimens for microscopic examination.

### BACKGROUND

Improper specimen preparation can interfere with the accuracy of microscopic analysis. Cutting a specimen is often one step in specimen preparation. A good cut, which minimizes marks and distortions to the specimen sample during the cutting step, is important to ensure that the sample is in proper condition for microscopic examination. The microscopic analysis should reflect the characteristics of the material being tested and not be distorted by defects caused by a bad cut.

Typical methods of cutting a specimen include microtoming or cutting with an instrument such as a scalpel. These methods are particularly useful for very soft specimens such as human tissue. Some other cutting methods use diamond saws, broad beam ion milling and focused ion beam (FIB). These methods are particularly useful for very hard materials such as semiconductors. Some other cutting methods use an apparatus that simultaneously stretches a specimen as it is cut. These known methods often drag the surface of a cutter through a specimen leaving markings on the specimen surface that reflect the effect of dragging the cutter. In other known methods, a specimen is placed on a surface. As a cutter is pushed through the specimen, as in a guillotine cut, the specimen can be distorted creating an uneven cut.

Accordingly, it is desirable to provide new methods and apparatuses for cutting specimens for microscopic examination.

### SUMMARY

Methods and apparatuses for cutting specimens for microscopic examination are provided. In some embodiments, cutting apparatuses are provided, the cutting apparatuses comprising: a base; a first platen and a second platen that are coupled to the base and that are configured to hold a specimen, wherein the first platen includes a first cutting surface and the second platen includes a second cutting surface; a moveable carriage that is moveably coupled to the base; a cutting arm that is pivotably coupled at a pivot point to the moveable carriage and that is configured to hold a cutting blade; and a spring coupled to the cutting arm so as to apply a directional force to the cutting arm and the cutting blade, wherein the moveable carriage can be moved in a manner that causes the cutting blade to slide on at least one of the first cutting surface and the second cutting surface while being pressed against the at least one of the first cutting surface and the second cutting surface by the directional force.

In some embodiments, cutting apparatuses are provided, the apparatuses comprising: a base; a first platen and a second platen that are coupled to the base and that are configured to hold a specimen, wherein the first platen includes a first cutting surface and the second platen includes a second cutting surface; a moveable carriage that is moveably coupled to the base; a cutting arm that is pivotably coupled at a pivot point to the moveable carriage and that is configured to hold a cutting blade; and a means for applying a directional force to the cutting arm and the cutting blade, wherein the moveable carriage can be moved in a manner that causes the cutting blade to slide on at least one of the first cutting surface and the second cutting surface while being pressed against the at least one of the first cutting surface and the second cutting surface by the directional force.

### BRIEF DESCRIPTION OF THE DRAWINGS

FIG. 1A is a top view of an example of a cutting apparatus prior to cutting in accordance with some embodiments of the disclosed subject matter.

FIG. 1B is a side view of an example of a cutting apparatus prior to cutting in accordance with some embodiments of the disclosed subject matter.

FIG. 1C is a perspective view of an example of a cutting apparatus in accordance with some embodiments of the disclosed subject matter.

FIG. 2A is a top view an example of a specimen holder in an open position in accordance with some embodiments of the disclosed subject matter.

FIG. 2B is a top view of an example of a specimen holder in a closed position in accordance with some embodiments of the disclosed subject matter.

FIG. 2C is a side view of an example of a specimen holder in accordance with some embodiments of the disclosed subject matter.

FIG. 3A is a top view of an example of a specimen holder in which both platens can move in accordance with some embodiments of the disclosed subject matter.

FIG. 3B is a top view of an example of a specimen holder in which both platens can move in accordance with some embodiments of the disclosed subject matter.

FIG. 4A is a side view of an example of a cutting apparatus prior to cutting a specimen in accordance with some embodiments of the disclosed subject matter.

FIG. 4B is a side view of an example of a cutting apparatus after cutting a specimen in accordance with some embodiments of the disclosed subject matter.

FIG. 5A is a side view of an example of a cutting blade and a specimen holder with an angle α between the cutting blade and a cutting surface of the specimen holder in accordance with some embodiments of the disclosed subject matter.

FIG. 5B is a top view of an example of a cutting blade and a specimen holder with an angle β between the cutting blade and an edge of a specimen in the specimen holder in accordance with some embodiments of the disclosed subject matter.

FIG. 6 is a flow chart of an example of a method of using cutting apparatuses, such as those illustrated in FIGS. 1-5, in accordance with some embodiments of the disclosed subject matter.

### DETAILED DESCRIPTION

In accordance with some embodiments of the disclosed subject matter, mechanisms (which can include methods, devices, apparatuses, systems, etc.) for cutting specimens for microscopic examination are provided. In some embodiments, these mechanisms can be useful for cutting specimens composed of materials with any suitable ranges of hardness. For example, in some embodiments, these mechanisms can be used to cut specimens composed of materials such as elastomers and plastics. The hardness of a material can be expressed, for example, by its elongation-to-break percentage (which can also be referred to as its ultimate elongation) or by its durometer (Shore hardness). In some embodiments, the mechanisms can be used to cut specimens exhibiting elongation-to-break percentages between 2% and 2000%, between 5% and 1000%, and/or in any other suitable range(s) of elongation-to-break percentages. In some embodiments, the mechanisms can be used to cut specimens with Shore hardness values between 30 Shore A and 100 Shore A, between 50 Shore A and 75 Shore A, and/or in any other suitable range(s) of Shore A values. While these example specimen elongation-to-break percentages and Shore A values are provided for purposed of illustration, it should be apparent to a person of ordinary skill in the art that the mechanisms described herein can be used to cut specimens having any suitable elongation-to-break percentages and/or Shore A values in some embodiments.

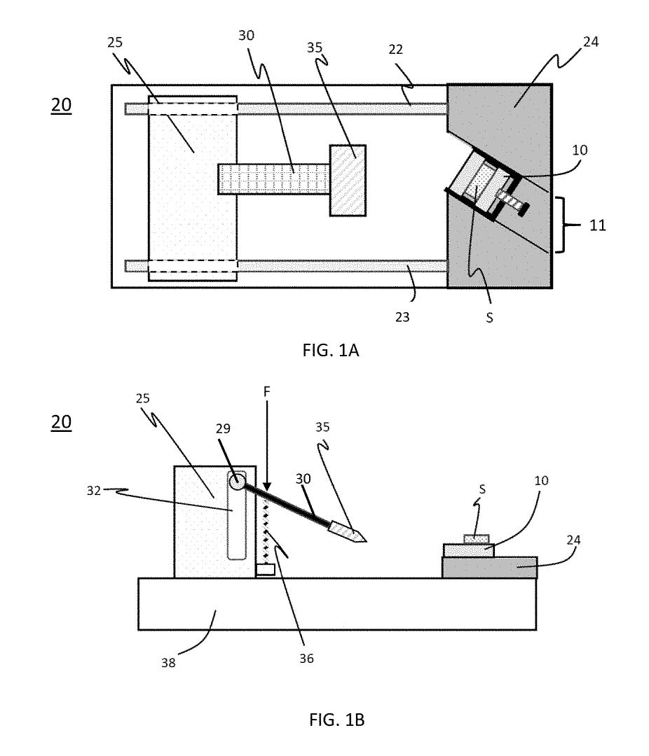

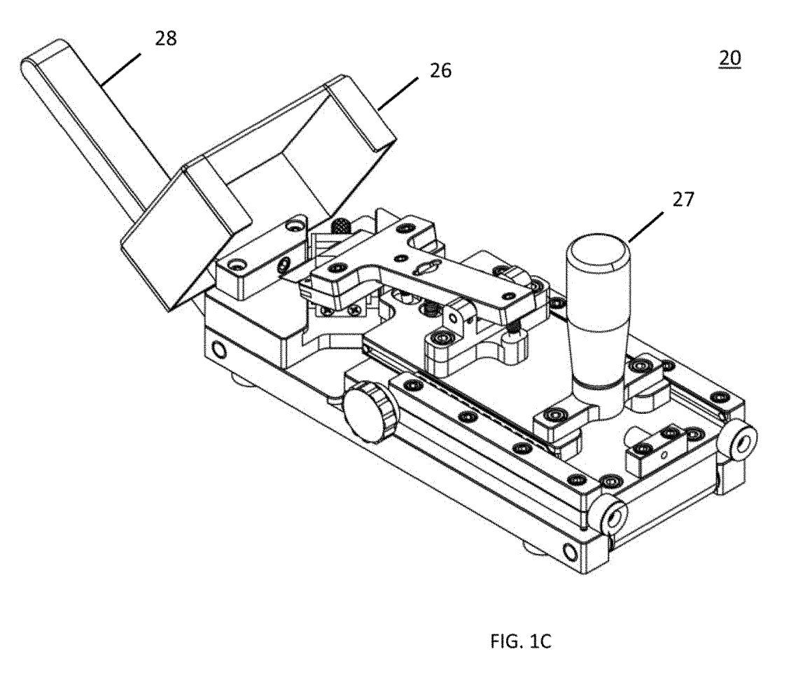

FIGS. 1A (top view) and 1B (side view) illustrate an example 20 of a cutting apparatus according to some embodiments of the disclosed subject matter. As shown, cutting apparatus 20 includes a base 38 that supports the other components of cutting apparatus 20, a moveable carriage 25 that is guided by bearings 22 and 23, a cutting arm 30, a cutting blade 35 that is attached to cutting arm 30, a spring 36 that applies a downward force F on cutting arm 30, and a specimen holder 10 that is held in apparatus 20 by mounting fixture 24.

Base 38 can be any suitable base formed from any suitable materials. For example, in some embodiments, base 38 can be formed from aluminum, steel, and/or any other suitable material(s). The surface of base 38 on which the other components of cutting apparatus 20 are mounted should be at least flat enough to ensure that the cutting geometry (described below) of cutting apparatus 20 is maintained.

Movable carriage 25 can be any suitable movable carriage formed from any suitable materials. For example, in some embodiments, movable carriage 25 can be formed from aluminum, steel, and/or any other suitable material(s).

Bearings 22 and 23 can be any suitable bearing structures. For example, in some embodiments, bearings 22 and 23 can be structures including bearing tracks mounted to base 38 that contain roller bearings mounted on pins coming out of the sides of the movable carriage (like a set of four wheels for the carriage, where two wheels are attached to each of two opposite sides of the carriage and run in the bearing tracks). Any suitable roller bearings, pins (which can be bolts, screws, or any other suitable fastener), and tracks can be used in some embodiments.

Cutting arm 30 can be any suitable cutting arm formed from any suitable materials. For example, in some embodiments, cutting arm 30 can be formed from aluminum, steel, and/or any other suitable material(s). As shown in FIG. 1B, cutting arm 30 can be pivotably mounted to movable carriage 25 such that arm 30 can rotate around point 29 in some embodiments. As also shown in FIG. 1B, the height of cutting arm 30 can be adjusted (e.g., manually) by repositioning point 29 along height adjustment slot 32 in some embodiments.

Cutting blade 35 can be any suitable cutting blade formed from any suitable materials. For example, in some embodiments, cutting blade 35 can be formed from tungsten carbide, steel, and/or any other suitable material(s). More particularly, for example, cutting blade 35 can be implemented using part number 0308.0228 blades from LUTZ GmbH & Co. KG of Solingen Germany in some embodiments. As another example, cutting blade 35 can be a disposable blade in some embodiments.

In some embodiments, cutting blade 35 can be removable from cutting arm 30 and can be held in cutting arm 30 by gripping faces (not shown) that are held in place by thumb screws or any other suitable mechanism (not shown).

In some embodiments, spring 36 can be configured to apply a constant, known and adjustable downward pressure to cutting arm 30 and cutting blade 35. For example, in some embodiments, spring 36 can be designed so that a consistent, downward pressure is maintained on cutting arm 30 and cutting blade 35 as cutting blade 35 moves across a cutting surface and passes through a specimen. More particularly, for example, in some embodiments, spring 36 can be implemented using a tension spring mounted between arm 30 and carriage 25 so as to pull arm 30 downward. Still more particularly, in some embodiments, spring 36 can be implemented using a tension spring made of spring steel and the tension of the tension spring can be adjusted for a particular specimen by controlling how much the spring is stretched.

Although arm 30 is illustrated herein as being pulled down by spring 36 in accordance with some embodiments, in some embodiments, a downward force can additionally or alternatively be applied to arm 30 using any other suitable mechanism. For example, in some embodiments, instead of using a spring 36 to pull down on arm 30, a fixed mass hanging from cutting arm 30 can apply a downward force. As another example, in some embodiments, a stretched pneumatic cylinder with a fixed pressure (so as to apply a tensile force) mounted between arm 30 and carriage 25 can be used to pull arm 30 downward.

Although FIG. 1B show downward force being applied to cutting arm 30 from below, it should be apparent to one of ordinary skill in the art that a source of downward force can be positioned above cutting arm 30 and apply force downward on cutting arm 30 from above the arm in some embodiments. For example, in some such embodiments, a downward force can be applied to cutting arm 30 from above the arm using a compressed spring positioned between a top side the cutting arm and a member (not shown) of carriage 25, placing a known mass on cutting arm 30, using a compressed pneumatic cylinder with fixed air pressure positioned between a top side the cutting arm and a member (not shown) of carriage 25, and/or using any other suitable mechanism.

In some embodiments, a spiral torsion spring mounted at point 29 can be pre-tensioned and attached at one side to carriage 25 and at the other side attached to arm 30 to apply a downward force to the arm.

In some embodiments, the desired downward force to be applied to cutting arm 30 can be set prior to cutting blade 35 passing through a specimen. If the force applied is too small, then cutting blade 35 will lift as it passes through a specimen. On the other hand, if the force that is applied is too great, then cutting blade 35 may flex as it passes through a specimen and alter the angle of cut. The appropriate force to be applied is specific to the physical properties of a specimen and the selected cutting blade used to cut the specimen. In some embodiments, the force that can be applied is between 20 and 400 gf (grams force).

Mounting fixture 24 can be any suitable mounting fixture formed from any suitable materials. For example, in some embodiments, mounting fixture 24 can be formed from aluminum, steel, and/or any other suitable material(s). The surface of mounting fixture 24 on which specimen holder 10 is mounted should be at least flat enough to ensure that the cutting geometry (described below) of cutting apparatus 20 is maintained.

FIG. 1C shows a perspective view of cutting apparatus 20 in accordance with some embodiments. As shown in this figure, cutting apparatus 20 can also include a safety shield 26, safety shield handle 28 and a carriage handle 27. In some embodiments, the safety shield can be positioned by the safety shield handle 28 in the down position during the cutting process so as to prevent possible injury to an operator from contacting the blade during the cutting process. The carriage handle can be used to move the movable carriage through a cutting motion and to prevent the operator from placing an operator imposed downward force on the cutting arm. Although carriage handle 27 is shown in FIG. 1C for manually moving moveable carriage through a cutting motion, the moveable carriage can be moved using any suitable mechanism such as an electric, hydraulic, or pneumatic actuator in some embodiments.

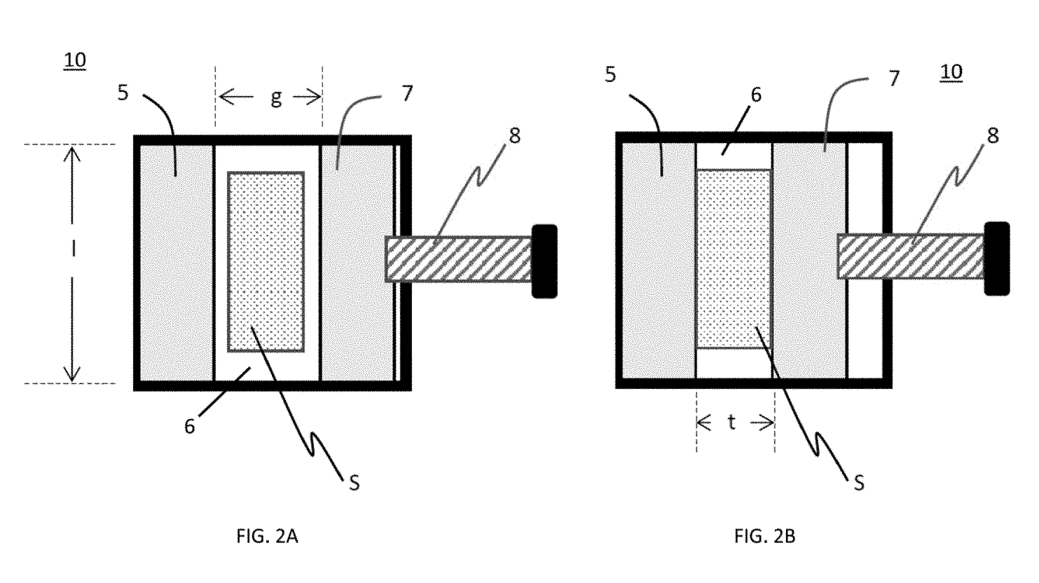

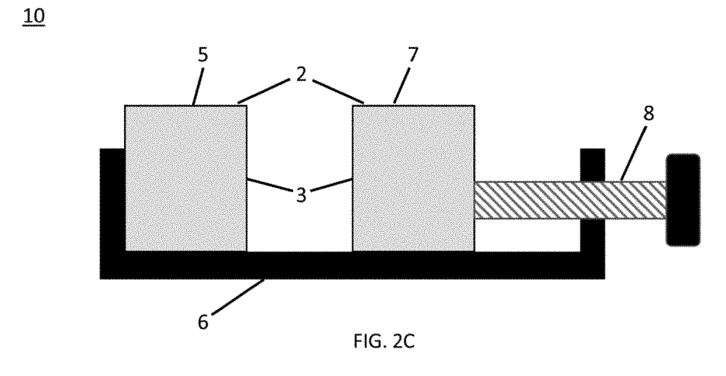

Specimen holder 10 can be any suitable specimen holder formed from any suitable materials in some embodiments. For example, specimen holder 10 can be formed as shown in FIGS. 2A, 2B, and 2C in some embodiments. As illustrated in these figures, specimen holder 10 can include a specimen holder body 6, platens 5 and 7, and an actuator 8.

Specimen holder body 6 can be any suitable specimen holder body formed from any suitable materials. For example, in some embodiments, specimen holder body 6 can be formed from aluminum, steel, and/or any other suitable material(s). The surface of specimen holder body 6 on which platens 5 and 7 are positioned should be at least flat enough to ensure that the cutting geometry (described below) of cutting apparatus 20 is maintained.

Platens 5 and 7 can be any suitable platens formed from any suitable materials. For example, in some embodiments, platens 5 and 7 can be formed from aluminum, steel, and/or any other suitable material(s). As shown in FIG. 2C, top surfaces of platens 5 and 7 can form cutting surfaces 2 of the platens and inside surfaces of platens 5 and 7 can form gripping surfaces 3 of the platens.

Actuator 8 can be any suitable actuator formed from any suitable materials. For example, in some embodiments, can be formed from a bolt that is threaded to match threads in specimen holder body (see, e.g., FIG. 2C).

According to some embodiments, as shown in FIGS. 2A and 2B, specimen S can be secured in specimen holder 10 during cutting. Specimen holder 10 can also be used to hold the cut specimen in place during microscopic examination. FIG. 2A shows specimen holder 10 in an open position and FIG. 2B shows specimen holder 10 in a closed position. In an illustrative embodiment, specimen holder 10 is configured so at least one platen is moveable. For example, in FIGS. 2A and 2B, platen 7 is moveable by actuator 8. Actuator 8 may move platen 7 towards or away from fixed platen 5. In other embodiments, both platens may be moveable, in which case another actuator may be provided to move platen 5 or actuator 8 may be configured to move both platens 5 and 7 towards or away from each other. The actuator may be operated manually by turning a screw or automatically by motor or pneumatic actuation. Locking pliers (not shown), bolts connecting the platens and the specimen holder body (not shown), and/or any other suitable mechanism can be used to lock platens 5 and 7 in place. The maximum opening of gap g between platens 5 and 7 determines the maximum thickness of useable specimens. In some embodiments, for example, the maximum opening gap g can be between 1 mm and 10 mm, the length of specimen S can be between 10 and 30 mm, and the thickness of specimen S can be between 5 and 10 mm. However, a person of skill in the art would understand that other dimensions can be used in some embodiments, including a maximum opening gap g greater than 1 mm and 10 mm.

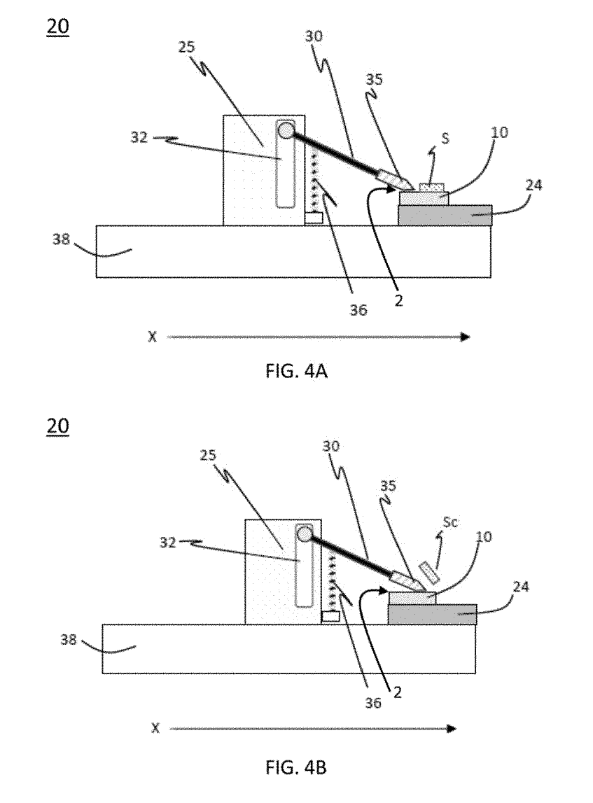

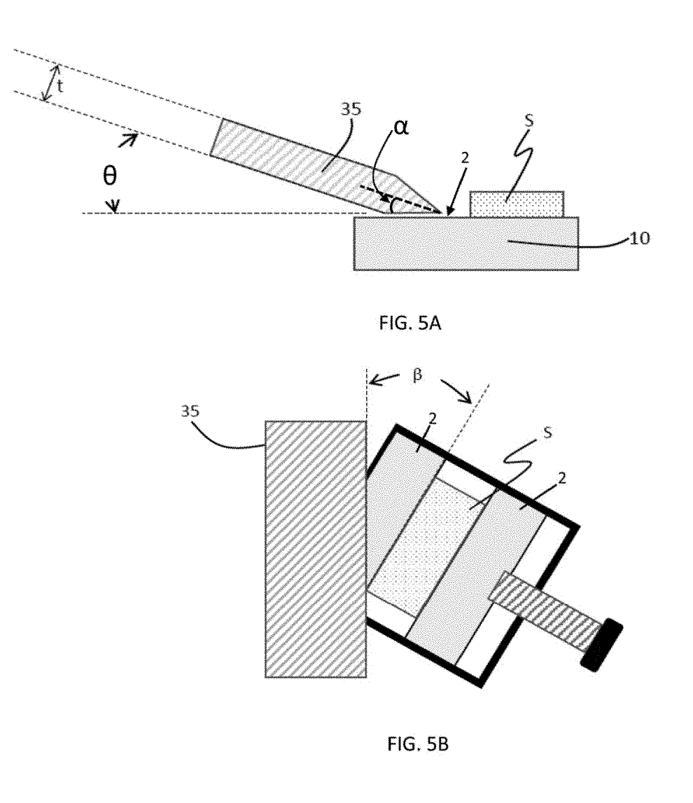

As mentioned above, in some embodiments, different components of cutting apparatus 20 can be configured to provide a suitable cutting geometry. As shown in FIGS. 4A, 4B, 5A, and 5B, when cutting blade 35 is cutting a specimen, the cutting blade rides along at least one of cutting surfaces 2 of platens 5 and 7. In some embodiments, cutting surfaces 2 of platens 5 and 7 are positioned at substantially the same planar level to provide a flat surface for cutting blade 35. Placing the cutting surfaces of platens 5 and 7 at substantially the same planar level and having the edge of cutting blade 35 substantially lie in, or just above, this planar level can be to provide a suitable cutting geometry and to help facilitate a good cut, in some embodiments.

The planar relationship between cutting surfaces 2 of platens 5 and 7 can also be relevant to the microscopic examination of a cut specimen and to ensuring that the entire cut specimen remains within the depth of field (DOF) of a microscopic objective. The DOF may vary by the objective magnification of the microscope, the microscope manufacturer and the microscope optical design. For example, an objective with a 5× magnification has a DOF of about 20 μm. If the planes at the cutting surfaces of platens 5 and 7 used with a 5× magnification objective are more than 20 μm apart, then part of the cut specimen may be in focus while part of the cut specimen may be out of focus. Therefore, in some embodiments, a suitable cutting geometry can require that the distance between the closest points of the plane of cutting surface 2 of platen 5 and the plane of cutting surface 2 of platen 7 be less than the DOF of the microscopic objective used for examination (e.g., 20 μm). In some embodiments, a suitable cutting geometry can require that the distance between the closest points of the plane of cutting surface 2 of platen 5 and the plane of cutting surface 2 of platen 7 be less than 0.5 times the DOF of the microscopic objective used for examination (e.g., 10 μm). Although specific example distances between the closest points of the plane of cutting surface 2 of platen 5 and the plane of cutting surface 2 of platen 7 are provided herein for purposed of illustration, any suitable distances can be used in some embodiments.

Because cutting surfaces 2 of platens 5 and 7 act as a guide for cutting blade 35, it is desirable to remove irregularities in the cutting surfaces of the platens to prevent cutting blade 35 transferring to a specimen any defects or marks as a result of such irregularities. According to some embodiments, the cutting surfaces of the platens can be ground and polished to remove irregularities on the surface of the platens resulting in a suitable Roughness Average (Ra). For example, in some embodiments, the Roughness Average of the cutting surfaces can be determined to be suitable when less than 10 μm. As another example, in some embodiments, the Roughness Average of the cutting surfaces can be determined to be suitable when less than 1 μm. Although example suitable Roughness Averages are described herein, the desired level of smoothness of the cutting surfaces of the platens can be determined by any suitable criteria, such as the ultimate application of a specimen, including the magnification used in final examination.

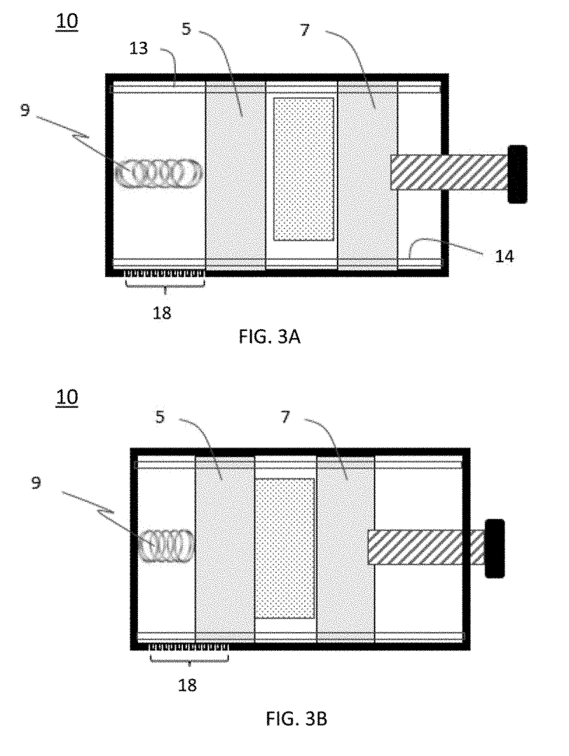

In some embodiments, as shown in FIGS. 3A and 3B, platens 5 and 7 may travel along guide rods or bearings 13 and 14.

In some embodiments, when implemented using bearings, bearing 13 and 14 can be any suitable bearing structures. For example, in some embodiments, the bearings can be structures including bearing tracks mounted to specimen holder 6 that contain roller bearings mounted on pins coming out of the sides of platens 5 and 7 (like a set of four wheels for each platen, where two wheels are attached to each of two opposite sides of the platen and run in the bearing tracks). Any suitable roller bearings, pins (which can be bolts, screws, or any other suitable fastener), and tracks can be used in some embodiments.

In some embodiments, specimen S is secured in specimen holder 10 by actuating moveable platens 7 and 5. Platen 5 may be moved towards spring 9, until the spring is compressed a desired amount, and platen 7 may be moved towards platen 5 to secure and apply pressure to specimen S, as shown in FIGS. 3A and 3B. When testing multiple specimens, applying consistent pressure to secure each specimen may facilitate more uniform results. The pressure may be controlled using a spring 9 situated between a side wall of specimen holder 6 and either platen 5 and 7. In securing specimen S, the platen closest to spring 9 (e.g., platen 5) may move towards spring 9, compressing the spring and causing pressure to be applied to the platen and specimen S.

In some embodiments, a Vernier scale 18 may be added to specimen holder 10 to measure the final positions of platens 5 and 7 once the specimen is secured. If platen 7 remains fixed and platen 5 moves to the same position for each specimen that is secured, the spring will compress the same amount and exert the same pressure on each specimen S. FIG. 3A, shows an embodiment of specimen holder 10 that includes an extended spring 9, indicating that no pressure is being applied by the spring. FIG. 3B, shows an embodiment of specimen holder 10 that includes a compressed spring 9, indicating that some pressure is being applied.

Although spring 9 is illustrated as applying pressure to platen 5, it should be apparent to a person of ordinary skill in the art that any suitable mechanism can be used to apply pressure to platen 5. For example, in some embodiments a compressed pneumatic cylinder with a fixed air pressure can be used to apply pressure to platen 5.

A person of skill in the art would understand that there are other ways to apply and measure pressure including using a gauge situated between specimen S and either platen 5 and 7.

In some embodiments, specimen S is positioned between platens 5 and 7 so that a portion of specimen S protrudes above the platens. The protruding portion represents the portion of specimen S to be cut by cutting apparatus 20 and the specimen portion remaining between platens 5 and 7 is the sample used for microscopic examination.

In an illustrative use, as shown in FIGS. 1A and 1B, once specimen S is secured, specimen holder 10 is placed in cutting apparatus 20 at mounting fixture 24. Mounting fixture 24 is configured so that specimen holder 10 is held firmly in place without movement when cutting blade 35 passes through specimen S. A person of skill in the art would understand that there are several ways for specimen holder 10 to be held in mounting fixture 24, including by locking pliers, bolts, or by an angled slot.

Once specimen holder 10 is secured in cutting apparatus 20, carriage 25 is moved in direction x until cutting blade 35 is in contact with specimen holder 10, but not touching specimen S as shown in FIG. 4A. The movement is continued in direction x until specimen S is fully cut as shown in FIG. 4B. The cut piece of the specimen (Sc) may be discarded. The remaining specimen held in specimen holder 10 may be the specimen used in examination and specimen holder 10 with the remaining specimen may be moved to a microscope for sample examination. In some embodiments, the specimen holder is placed in a microscope so that the cut edge of the cut specimen is perpendicular to the optical axis of the microscope and in focus.

Cutting blade 35 and its relationship to specimen S and specimen holder 10 are shown in illustrative embodiments FIG. 5A and FIG. 5B.

Turning to FIG. 5A, the dimensions for cutting blade 35 are represented by thickness t and edge angle α. Thickness t of a blade refers to the thickness of the blade at its thickest point. Edge angle α refers to the angle between a tapered surface of the blade and the centerline of the blade as illustrated in FIG. 5A. Blade angle θ refers to the elevation angle of the blade in relation to specimen holder 10.

In general, thickness t of cutting blade 35 should be as thin as possible, but not too thin that the blade deforms when cutting a specimen. According to some embodiments, for example, the thickness of cutting blade 35 may be between 0.1 mm and 1 mm, between 0.2 and 0.5 mm, or in any other suitable range of thicknesses. A person of skill in the art would understand the different shaped blades, for example, rectangular and arced, may be used in some embodiments.

Similarly, in general, edge angle α should be as small as possible to minimize the shear forces applied to the specimen by the tapered surfaces of the blade when cutting.

In some embodiments, blade angle θ should be matched to edge angle α to minimize shearing forces to the portion of the specimen remaining after cutting. In some embodiments, for example, that edge angle α and the blade angle θ may be between 2 and 25 degrees, between 10 and 20 degrees, or in any other suitable range of angles. In some embodiments, blade angle θ can be set prior to cutting blade 35 making contact with a specimen. In some embodiments for example, blade angle θ may be equal to or greater than edge angle α and less than 45 degrees.

The size ranges for the thickness t and the angle ranges for edge angle α and blade angle θ provided herein are for illustration only and a person of skill in the art would understand that other size ranges and angle ranges are possible. In some embodiments, the thickness t, edge angle α, and blade angle θ can be selected so that a desired flat cut, with no or minimal cut mark is obtained.

Turning to FIG. 5B, in an illustrative use, prior to cutting a sample, cutting blade 35 can be placed at an angle β to the orientation of specimen S. The angle β can be adjusted to aid in making a smooth cut and may vary between 0 and 90 degrees. Optimal angles are specimen dependent. Blade angle θ and angle β can be set prior to cutting blade 35 making contact with specimen S in some embodiments. In an illustrative use, cutting blade 35 moves some distance across the cutting surface of either or both platens 5 and 7 before cutting blade 35 makes contact with specimen S in some embodiments. For example, in some embodiments, cutting blade 35 may travel a distance of 2 or 3 mm before cutting blade 35 makes contact with specimen S, although any other suitable distance can be used in some embodiments.

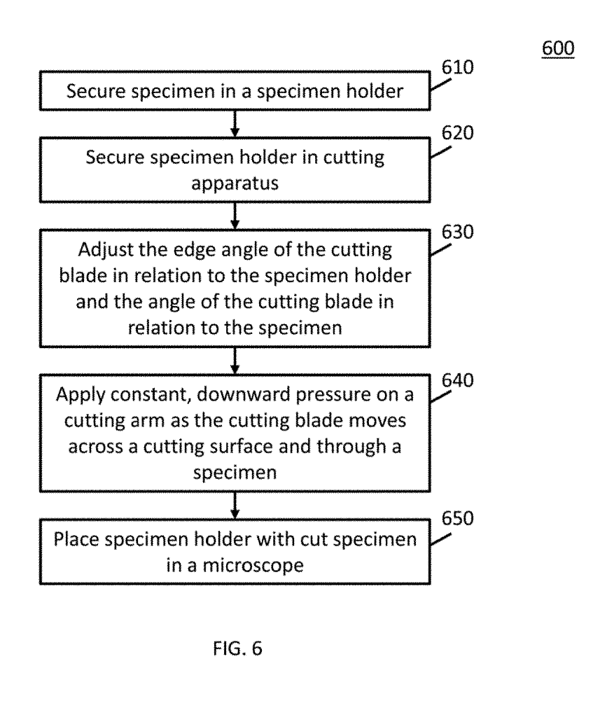

FIG. 6, with further reference to FIGS. 1-5, shows at a high level, cutting process 600, in accordance with some embodiments of the disclosed subject matter. The cutting process 600 may use cutting apparatus 20. The division of when the particular portions of process 600 are performed can vary, it being understood that no division or a different division is within the scope of the invention. It should be understood that at least some of the portions of process 600 described herein can be performed in any order or sequence not limited to the order and sequence shown in and described in the figure. Also, some of the portions of process 600 described herein can be or performed substantially simultaneously where appropriate or in parallel. Additionally or alternatively, some portions of 600 can be omitted.

At step 610, a specimen S can be secured in specimen holder 10 by moving any one or both of platens 5 and 7. As discussed above, the specimen S can be secured in specimen holder 10 by applying a known pressure in some embodiments.

At step 620, specimen holder 10 with secured specimen S can be placed in cutting apparatus 20 at mounting fixture 24 to hold specimen holder 10 firmly in place while cutting blade 35 makes contact with specimen holder 10 and specimen S. In some embodiments, specimen holder 10 may be placed in cutting apparatus 20, before specimen S is secured within specimen holder 10.

At step 630, as described herein, cutting blade angle θ and angle β can be set prior to cutting blade 35 making contact with specimen S.

At step 640, carriage 25 can be moved in direction x (as shown in FIGS. 4A and 4B) and a constant, downward pressure can be applied as cutting blade 35 moves first across one or more of the cutting surfaces of platens 5 and 7 and then as cutting blade 35 cuts specimen S.

At step 650, specimen holder 10 holding cut specimen S can be placed in a microscope. In some embodiments, specimen S can be positioned so that the cut edge of the cut specimen is perpendicular to the optical axis of the microscope and in focus.

The cutting apparatus and method have been described in detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

1. A cutting apparatus comprising:
a base;
a first platen and a second platen that are coupled to the base and that are configured to hold a specimen by moving with respect to each other and applying a compressive force to the specimen, wherein the first platen includes a first cutting surface and the second platen includes a second cutting surface;
a moveable carriage that is moveably coupled to the base;
a cutting arm that is pivotably coupled at a pivot point to the moveable carriage so that the cutting arm pivots about the pivot point in an arc and that is configured to hold a cutting blade; and
a spring coupled to the cutting arm so as to apply a directional force to the cutting arm and the cutting blade,
wherein the moveable carriage is moveable in a manner that causes the cutting blade to slide on at least one of the first cutting surface and the second cutting surface while being pressed against the at least one of the first cutting surface and the second cutting surface by the directional force.

2. The cutting apparatus of claim 1, wherein the first cutting surface and the second cutting surface are at substantially the same planar level.

3. The cutting apparatus of claim 2, wherein a distance between closest points of a plane of the first cutting surface and a plane of the second cutting surface are less than 20 μm.

4. The cutting apparatus of claim 3, wherein a distance between closest points of a plane of the first cutting surface and a plane of the second cutting surface are less than 10 μm.

5. The cutting apparatus of claim 1, wherein at least one of the first cutting surface and the second cutting surface is ground and polished.

6. The cutting apparatus of claim 1, wherein at least one of the first cutting surface and the second cutting surface has a Roughness Average of less than 10 μm.

7. The cutting apparatus of claim 6, wherein at least one of the first cutting surface and the second cutting surface has a Roughness Average of less than 1 μm.

8. The cutting apparatus of claim 1, wherein a location of the pivot point on the moveable carriage is adjustable.

9. The cutting apparatus of claim 1, wherein the spring is a selected one from the group consisting of a tension spring, a compressive spring and a spiral torsion spring.

10. The cutting apparatus of claim 1, wherein the moveable carriage is coupled to the base by roller bearings and bearing tracks.

11. (canceled)

12. The cutting apparatus of claim 1, wherein a spring is coupled to one of the first platen and the second platen to exert a force on the one of the first platen and the second platen.

13. The cutting apparatus of claim 1, wherein the moveable carriage includes a handle for manually moving the moveable carriage with respect to the base.

14. The cutting apparatus of claim 1 further comprising a cover over the first platen and the second platen.

15. The cutting apparatus of claim 1, further comprising an actuator for manually moving at least one of the first platen and the second platen.

16. The cutting apparatus of claim 1, wherein the first platen and the second platen are coupled to a body that is removably coupled to the base.

17. The cutting apparatus of claim 16, wherein the body is removably coupled to the base by a slot.

18. The cutting apparatus of claim 1, wherein a blade angle θ of the cutting blade with respect to at least one of the first cutting surface and the second cutting surface is: greater than or equal to an edge angle α of the cutting blade; and less than or equal to 45 degrees.

19. A cutting apparatus comprising:
a base;
a first platen and a second platen that are coupled to the base and that are configured to hold a specimen by moving with respect to each other and applying a compressive force to the specimen, wherein the first platen includes a first cutting surface and the second platen includes a second cutting surface;
a moveable carriage that is moveably coupled to the base;
a cutting arm that is pivotably coupled at a pivot point to the moveable carriage so that the cutting arm pivots about the pivot point in an arc and that is configured to hold a cutting blade; and
a means for applying a directional force to the cutting arm and the cutting blade,
wherein the moveable carriage is moveable in a manner that causes the cutting blade to slide on at least one of the first cutting surface and the second cutting surface while being pressed against the at least one of the first cutting surface and the second cutting surface by the directional force.

20. The cutting apparatus of claim 19, wherein the means for applying a directional force is a mass.
